(19) United States
(12) Patent Application Publication
(10) Pub. No.: US 2008/0078931 A1
(43) Pub. Date: Apr. 3, 2008

(54) Systems for interfacing separations with MALDI mass spectrometry

(75) Inventors: Marvin L. Vestal, Framingham, MA (US); Stephen J. Hattan, Lowell, MA (US)

Correspondence Address: ELMORE PATENT LAW GROUP, PC, 209 MAIN STREET, N. CHELMSFORD, MA, 01863, US

(73) Assignee: Virgin Instruments

(21) Appl. No.: 11/541,467

(22) Filed: Sep. 29, 2006

(51) Int. Cl. H01J 49/00

(52) U.S. Cl. 250/293

(57) ABSTRACT

The present invention is directed to improved systems and components for coupling separations technology with MALDI-TOF mass spectroscopy. Specifically, this invention provides new apparatus configurations and methods for interfacing liquid-phase separations with MALDI mass spectrometry. The present invention exploits and expands the use of the collimated hole structure (CHS) sample plate as an integral component of the interface.

### FIELD OF THE INVENTION

This invention relates generally to the field mass spectrometry, and more particularly relates to interfaces between matrix-assisted laser desorption/ionization mass spectrometry (hereinafter, “MALDI”) liquid separations systems including high performance liquid chromatography and capillary electrophoresis.

### BACKGROUND OF THE INVENTION

It is generally recognized that functional genomics, proteomics, and metabolomics will eventually provide new technologies that revolutionize diagnosis and treatment of disease. The human genome project has established the molecular approach to understanding biology, but present knowledge of how an organism functions at the molecular level is really very poor. Functional analyses must be carried out, not only at the level of gene expression (transcriptomics), but also at the level of protein translation and modification (proteomics), and the metabolite network (metabolomics). Further improvements in chemistry, separations science, mass spectrometry, and bio-informatics will be required to complete this revolution.

In the field of proteomics it is recognized that two-dimensional (2-D) gel electrophoresis is, by far, the most widely accepted technique for high-resolution separation of protein mixtures, and recently, alternatives such as multi-dimensional high-performance liquid chromatography (“HPLC”) and capillary electrophoresis have been developed.

Following separation, it is accepted that mass spectrometry (“MS”) employing either electrospray or MALDI is essential for protein identification and characterization with MALDI-TOF being typically the first method employed for protein identification with tandem MS-MS being the method of choice for identifying and characterizing proteins following digestion with enzymes such as trypsin. However no single MS-MS instrument or technique has established dominance.

In MALDI, samples are deposited on a surface, incorporated into crystals of a co-deposited matrix, and ions are desorbed directly into the gas phase by interaction with a pulsed laser beam.

In tandem MS-MS, peptide mixtures are introduced into the mass spectrometer as a continuous flow of a liquid solution, such as in nanospray. A molecular ion of interest is selected by the first MS. Selected ions are caused to fragment, usually by collision with a neutral gas, and the fragment ion masses and intensities are measured using the second MS. These techniques employ low energy collision-induced dissociation (CID) in which the ions are fragmented by a large number of relatively low energy collisions. An alternative technique is high energy CID in which the collision energy is sufficient to cause fragmentation as the result of a single collision, and the possible number of collisions that the ions undergo is small (i.e., <10). Prior to the development of tandem time-of-flight (TOF-TOF), high energy CID was available only on tandem magnetic sector instruments, or a hybrid of a magnetic sector with TOF.

While these instruments are complex and expensive, they are not readily interfaced with sensitive ionization techniques such as MALDI and electrospray.

Prior to the development of MALDI, combinations of separation techniques with mass spectrometry generally involved on-line direct coupling of the effluent from the chromatograph to the inlet of the mass spectrometer. Techniques such as electrospray, ionspray, and thermospray have been employed successfully with a variety of mass spectrometers, including TOF.

Recent advances in MALDI-TOF mass spectrometry combined with advances in 2-D gel electrophoresis and other separation techniques promise to revolutionize the speed and sensitivity of the separation, quantitation, identification, and characterization of proteins in complex mixtures. However, the interface between separations and mass spectrometry remains a major bottleneck to the full exploitation of both technologies.

Traditionally, to interface MALDI with liquid separation techniques such as HPLC or capillary electrophoresis (“CE”), droplets from the liquid effluent, usually with added matrix solution, are deposited sequentially on a suitable surface and allowed to dry. The surface containing the dried matrix and samples is then inserted into the vacuum system of the MALDI mass spectrometer and irradiated by the laser beam.

Some systems have been disclosed where the sample deposition takes place within the vacuum of the MS system and sample deposition and desorption are directly coupled. Karger et al, U.S. Pat. No. 6,175,112. In some systems the liquid is deposited on the surface in a continuous track and the liquid rapidly evaporated in a vacuum. Karger et al., U.S. Pat. Nos. 6,674,070 and 6,825,463.

The advantage of direct coupling between the separation and the MALDI mass spectrometer is that it behaves similarly to the more familiar direct coupling techniques such as electrospray, in that the time scales are the same. But this is also the main disadvantage of direct coupling. All of the measurements on an eluting peak must be made during the time that the peak is present in the effluent. Depending on the speed of the separation technique, this time may be as much as a minute or less than a second.

In a typical measurement on a protein digest, this may involve measurement of the peptide mass fingerprint in MS mode, deciding which peaks should be measured using MS-MS, and measuring all of the MS-MS spectra of interest. This means that the separation must be slowed down to accommodate the speed of the mass spectrometer, or some of the potential information about the sample is lost.

In contrast, off-line coupling as in MALDI allows the sample deposition to occur at a speed appropriate to the chromatography, and the mass spectrometer can be operated faster or slower as needed to maximize the information. For example, an entire liquid chromatography (“LC”) run can be rapidly scanned to determine the peptide mass fingerprints and relative intensities for all peptides in the run. This information can then be used in a true data-dependent manner to set up the MS-MS measurement for all of the spots on the plate to obtain the required information most efficiently. Since it rare for all of the sample to be used in most MALDI measurements, additional measurements can be made at any later time as needed.

### SUMMARY OF THE INVENTION

In view of the foregoing, the present invention is directed to improved systems and components for coupling liquid chromatography (LC) separations technology with MALDI-TOF mass spectroscopy. Specifically, this invention provides new apparatus configurations and methods for interfacing liquid-phase separations with MALDI-TOF and TOF-TOF mass spectrometry. The present invention exploits and expands the use of the collimated hole structure (CHS) sample plate disclosed in U.S. Ser. No. 11/138,127, filed on May 26, 2005, the entire contents of which are incorporated herein by reference.

The present invention is directed to interface methods and systems using a sample plate for MALDI employing collimated hole structures (CHS) that retains all of the required features of conventional sample plates commonly formed from stainless steel, but provides additional capacity for capturing and modifying samples of interest without significant sample loss and with negligible loss in spatial resolution.

Accordingly the interface system of the invention comprises a MALDI sample plate comprising a collimated hole structure (CHS), a sample deposition apparatus coupled between a separation system and the MALDI sample plate whereby liquid containing samples of interest is transferred to the MALDI sample plate so that samples separated in the separation system remain separated on the MALDI sample plate, and a matrix deposition apparatus coupled between the sample deposition apparatus and the mass spectrometer for adding MALDI matrix to the sample plate. The interface system of the invention may further comprise a washing apparatus coupled between the sample deposition apparatus and the matrix deposition apparatus to remove salts and other undesirable contaminants without significantly removing samples of interest. A second washing apparatus may also be employed after matrix deposition.

ABBREVIATIONS: atm, atmosphere; CHS, collimated hole structure; HPLC, high pressure or performance liquid chromatography; LC, liquid chromatography; MALDI, matrix-assisted laser desorption/ionization; MS, mass spectrometry or spectroscopy; TOF, time of flight;

### BRIEF DESCRIPTION OF THE DRAWINGS

The foregoing and other features and aspects of the present invention will be best understood with reference to the following detailed description of specific embodiments of the invention, when read in conjunction with the accompanying drawings, wherein:

FIG. 1 is a block diagram of a MALDI mass spectrometer interfaced to a liquid separation system employing one embodiment of the interface system of the invention.

FIG. 2 is a block diagram of a MALDI mass spectrometer interfaced to a liquid separation system employing another embodiment of the interface system of the invention.

FIG. 3 is a cross-sectional view of one embodiment of a sample deposition apparatus for coupling liquid effluent from a liquid separation to a collimated hole structure MALDI plate.

FIG. 4 is a cross-sectional view of one embodiment of a matrix deposition apparatus suitable for adding MALDI matrix to a collimated hole structure MALDI plate or for washing a collimated hole structure MALDI plate to remove salts and other contaminants.

FIG. 5 is a cross-sectional view of a portion of a MALDI mass spectrometer for receiving and analyzing samples on collimated hole structure MALDI plate.

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

### DETAILED DESCRIPTION OF THE INVENTION

A description of preferred embodiments of the invention follows.

In the disclosure that follows, in the interest of clarity, not all features of actual implementations are described. It will of course be appreciated that in the development of any such actual implementation, as in any such project, numerous engineering and technical decisions must be made to achieve the developers' specific goals and subgoals (e.g., compliance with system and technical constraints), which will vary from one implementation to another. Moreover, attention will necessarily be paid to proper engineering practices for the environment in question. It will be appreciated that such a development effort might be complex and time-consuming, but would nevertheless be a routine undertaking for those of ordinary skill in the relevant fields.

The present invention exploits and expands the use of the collimated hole structure (CHS) sample plate disclosed in U.S. Ser. No. 11/138,127, filed May 26, 2005. Accordingly, in one embodiment the collimated hole structure comprises a regular array of holes 0.025 mm in diameter arranged in hexagonal close-packed configuration with 0.035 mm spacing between holes. The collimated hole structure is 102×108×1.5 mm and is mounted in a 400 series magnetic stainless steel frame 124×127×3 mm. The total number of 0.025 mm diameter holes in the plate is approximately 10,384,000.

In another embodiment the hole diameters and spacings are as above, but the dimensions of the collimated hole structure is 30×30×1.5 mm and it is mounted in a stainless steel frame 50×50×1.5 mm. These are for illustration only since any size hole and plate can be used in the invention.

In yet another embodiment holes are formed in a 400 series magnetic stainless steel plate. In one such embodiment the outside dimensions of the plate are 124×127×3 mm, and the holes are 3 mm in diameter in a square array with 4.5 mm between holes within the central 102×108 mm region for a total of 528 holes in an array of 24×22 holes. In another such embodiment the holes are 1.5 mm in diameter in a square array with 2.25 mm between holes for a total of 2112 holes in an array of 48×44 holes.

In a preferred embodiment the holes in CHS plates are filled with a porous monolithic structure designed to preferentially adsorb samples of interest. One such embodiment employs formation of reversed phase mode styrene-divinylbenzene based monoliths. The reversed phase separation mode was chosen due to its near ubiquitous ability to capture peptides; a characteristic directly in-line with the initial applications of the plates. The initial formulations used in monolith construction herein were taken from published procedures for capillary HPLC monolithic column formation. C. W. Huck, G. K. Bonn, “Poly(Styrene-Divinylbenzene) Based Media for Liquid Chromatography, Chem. Eng. Technol. 28:457-1472 (2005). S. Xie, R. W. Allington, F. Svec, J. M. J. Frechet “Rapid Reversed-Phase Separation of Proteins and Peptides using Optimized ‘Moulded’ Monolithic Poly (Styrene-co-Divinylbenzene) columns, J. Chrom. A. 865:169-174 (1999).

For all polymer formulations, monolithic plate construction was paralleled with the creation of fused-silica capillary columns so that the separation behavior and loading capacity of the resulting media could be characterized by HPLC.

The collimated hole structure plates of the present invention have a high capture capacity. As used herein a “high capture capacity” means that the collimated hole structure plate captures samples of interest even when the volume of liquid effluent containing said samples of interest delivered to any predetermined location on the collimated hole structure plate is larger than the internal volume of the collimated hole structure at that location.

In one embodiment of the interface system of the invention, the liquid effluent delivered to one surface of the collimated hole structure sample plate at a predetermined location is efficiently vaporized at the opposite surface of the plate so that nonvolatile samples of interest in the liquid effluent are efficiently captured either within that portion of the collimated hole structure plate or on the opposite surface even though the volume of liquid delivered to that location may be larger than the internal volume of that portion of the collimated hole structure.

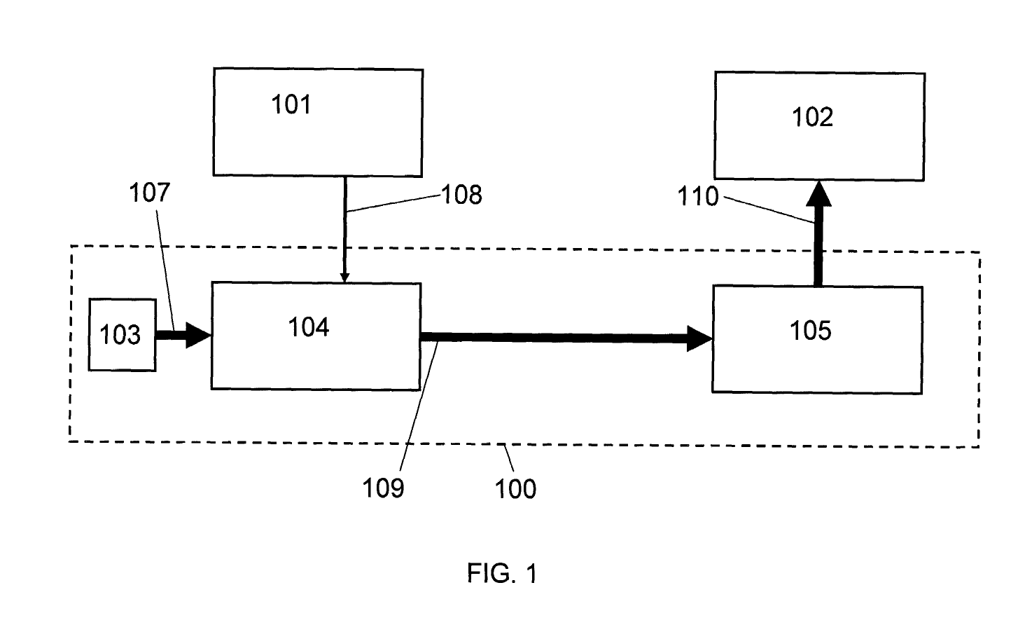

Referring now to FIG. 1. This is a block diagram of one embodiment of the interface system 100 according to the present invention coupling a liquid separation system 101 to a MALDI mass spectrometer 102 employing a collimated hole structure plate 104. The liquid separations system can be any separation system that separates samples of interest in a flowing liquid stream including, but not limited to, high performance liquid chromatography and capillary electrophoresis. The mass spectrometer may be any employing matrix-assisted laser desorption ionization (MALDI) including, but not limited to, quadrupole, ion trap, time-of-flight (TOF), magnetic deflection, and fourier transform ion cyclotron resonance (FTICR), as well as hybrid combinations. The interface 100 comprises a collimated hole structure sample plate (CHS) 103, and sample deposition apparatus 104 for coupling the effluent from the liquid separations system to predetermined locations on the CHS sample plate. The samples are captured within the holes of the CHS sample plate or on the surface of the side opposite the surface in communication with the liquid effluent. The interface system further comprises a matrix deposition apparatus 105 for adding MALDI matrix solution to the sample plate so that samples of interest captured on or within the CHS plate are eluted to one surface of the plate and are incorporated into matrix crystals on the surface as the matrix solution evaporates.

In operation the CHS sample plate is loaded either manually or using a mechanical transfer device 107 into the sample deposition apparatus 104 where liquid effluent 108 is transferred from the liquid separations device 101 onto predetermined locations on the CHS sample plate 103.

In one embodiment employing a CHS plate with 3 mm holes in a 24×22 array, the liquid effluent is initially directed to a hole at one corner of the array. After a predetermined time the effluent is directed to an adjacent hole in the array, and this procedure is repeated until effluent has been directed to all of the desired holes in the array, or until the separation is completed. After the plate is loaded with samples of interest, the sample plate 103 is transferred either manually or mechanically using a mechanical transfer device 109 to a matrix deposition apparatus 105 for adding MALDI matrix. In the matrix deposition apparatus 105 a solution of MALDI matrix in an appropriate solvent is added to one surface of the plate and caused to flow through the holes in the plate. The solvent composition is chosen so that samples of interest are eluted from the holes to the opposite surface of the plate. Solution reaching the opposite surface is evaporated to form matrix crystals incorporating samples of interest. The sample plate 103 is then transferred either manually or mechanically using a mechanical transfer device 110 to a MALDI mass spectrometer 102 where the surface of the plate containing matrix crystals with incorporated samples of interest are exposed to a laser beam, and the samples of interest are ionized and analyzed by mass spectrometry.

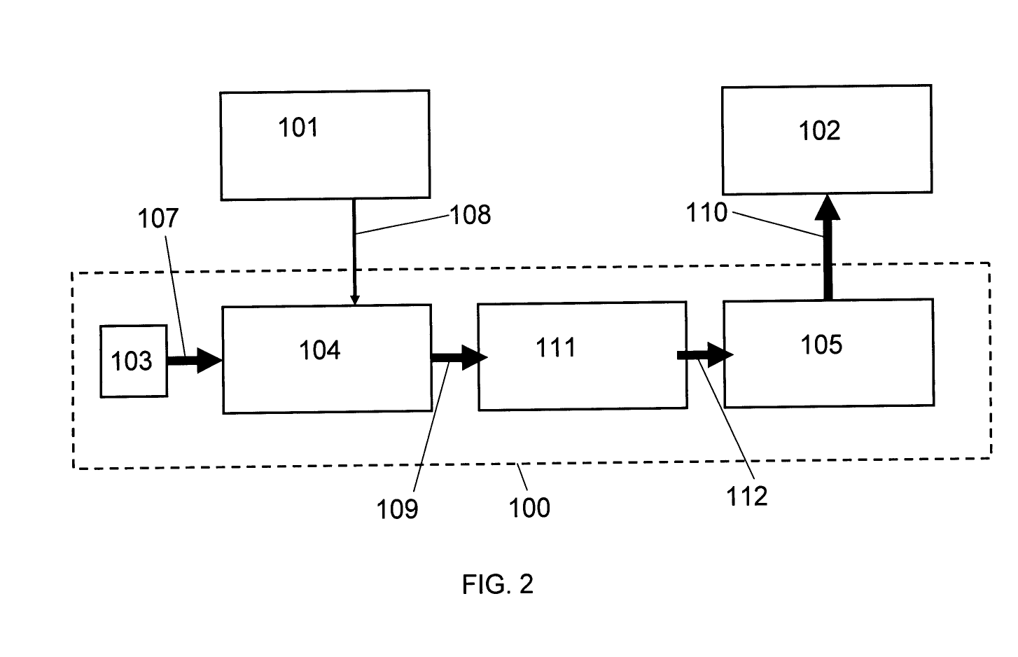

Referring now to FIG. 2. This is a block diagram of another embodiment of the interface system 100 of the present invention coupling a liquid separation system 101 to a MALDI mass spectrometer 102 employing a collimated hole structure plate 103. In addition to the elements shown in FIG. 1, this embodiment further comprises a washing apparatus 111 for washing sample plates following loading of samples of interest by the sample deposition apparatus 104 and before adding MALDI matrix by the matrix deposition apparatus 105. This embodiment further comprises a transfer device 109 for moving sample plates from the sample deposition apparatus 104 to the washing apparatus 111 and a transfer device 112 for moving sample plates from the washing apparatus 111 to the matrix deposition apparatus105. In some cases transfer of samples of interest to the CHS plate 103 from the liquid separation 101 may be accompanied by nonvolatile inorganic or organic salts or other contaminants. Often the properties of these contaminants are such that they are more weakly bound to the collimated hole structures than are the sample of interest. In such cases these contaminants can be washed away using a solvent that elutes the contaminants but does not significantly affect samples of interest. For example, most peptides bound to a reversed-phase medium will not be eluted in a predominately aqueous solvent but many contaminating salts are readily dissolved and removed.

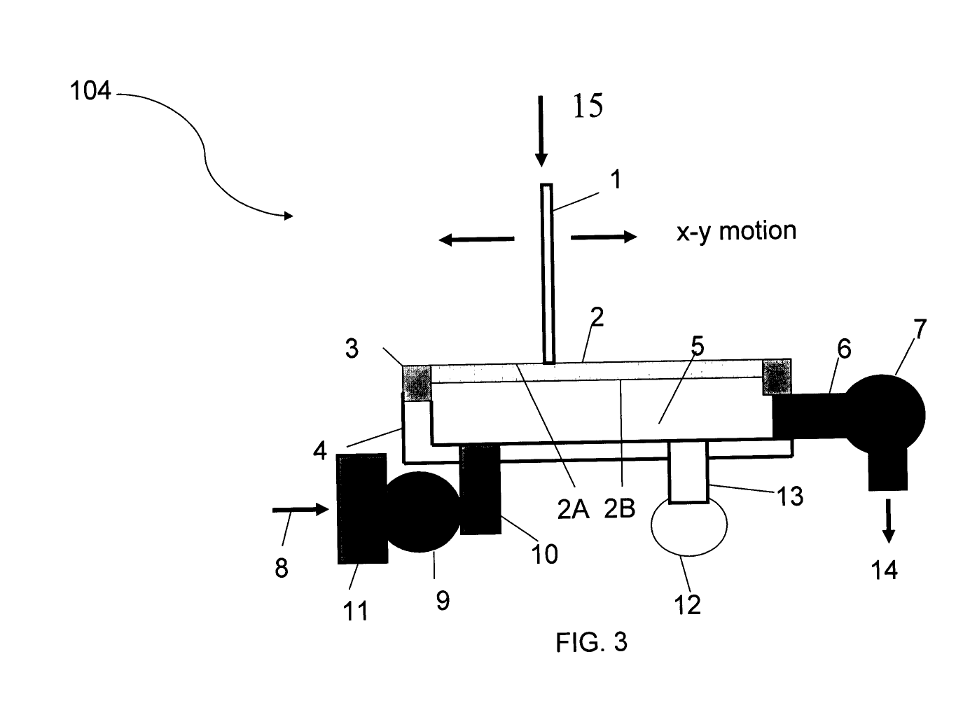

Referring now to FIG. 3. This represents a schematic cross-sectional view of one embodiment of a sample deposition apparatus 104 for coupling liquid effluent from a liquid separation to a collimated hole structure MALDI plate. This embodiment is suitable for interfacing liquid chromatography (LC) at any flow rate up to 1 mL/min, including cases involving 100% aqueous mobile phase. Effluent from the LC flows through a liquid inlet 15 to the connection tube 1 to a first surface of the CHS plate 2A of the collimated hole structure (CHS) plate 2.

In one embodiment the end of the connection tube is in close proximity to the surface of the CHS plate, but does not necessarily make contact with the plate. In another embodiment the end of the tube is enclosed in a sleeve that presses against the plate so that the flow is directed through the plate by the liquid pressure within the sleeve The CHS plate is rigidly mounted in a frame 3 and the frame is mounted onto a plate holder 4 and the chamber 5 is effectively isolated from the ambient air surrounding the connection tube 1. The chamber 5 is adjacent to a second surface of the CHS plate 2B of the plate and communicates with a vacuum generator (not shown) via a vacuum coupling 6 and an outlet flow controller 7. The vacuum generator need not be directly mounted to or on the interface apparatus. It need only be operably linked to the apparatus, preferably by a vacuum coupling. As used herein a vacuum coupling may be any tube, pipe, or system which affords fluid communication between the vacuum generator and the interfacing system.

Operationally, liquid effluent from the LC entering the inlet 15 is supplied to the first surface of the CHS plate 2A of the collimated hole structure plate 2 through connection tube 1, and the liquid flows through the plate driven by a pressure differential. The pressure differential can be generated across the plate, in which case the differential is that between the atmospheric pressure on opposite sides of the plate (i.e., determined by the gas flow). The flow across the plate may also be driven by a pressure differential generated between the pressure of the liquid effluent and the atmospheric pressure on opposite side of the plate from the effluent side. Optimum performance of the interface requires that samples of interest are captured on monolithic structures within the holes or on the second surface 2B. If samples of interest are only weakly bound to the monolithic polymer, then it is desirable that the liquid be completely vaporized as it emerges from the monolithic polymer structure at the opposite side, the second surface 2B of the plate. This assures that all of the nonvolatile solutes are retained on the plate even in cases in which binding to the polymeric structure is weak. On the other hand if samples are strongly retained within the holes, or if the volume of liquid supplied to each hole is less than the internal volume, then vaporization is not required.

If vaporization is required then the temperature of the plate and the partial pressure of the liquid vapor in the gas at the opposite surface of the plate must be controlled to assure that vaporization occurs at the surface.

To this end, a source of make-up air 8 is supplied and coupled to chamber 5 through an inlet flow controller 9 and inlet coupling 10. In one embodiment the make-up air is heated by a heater 11 sufficient to supply the heat of vaporization of the liquid. Inlet flow controller 9 and outlet flow controller 7 are used to set the desired pressure and total flow in the chamber 5 measured by pressure gauge 12 which is operably connected to the system via a pressure gauge coupling 13.

In supplying the sample-containing effluent to the surface of the plate the connection tube can move in both the x and y directions to any predetermined or directed spot on the CHS plate.

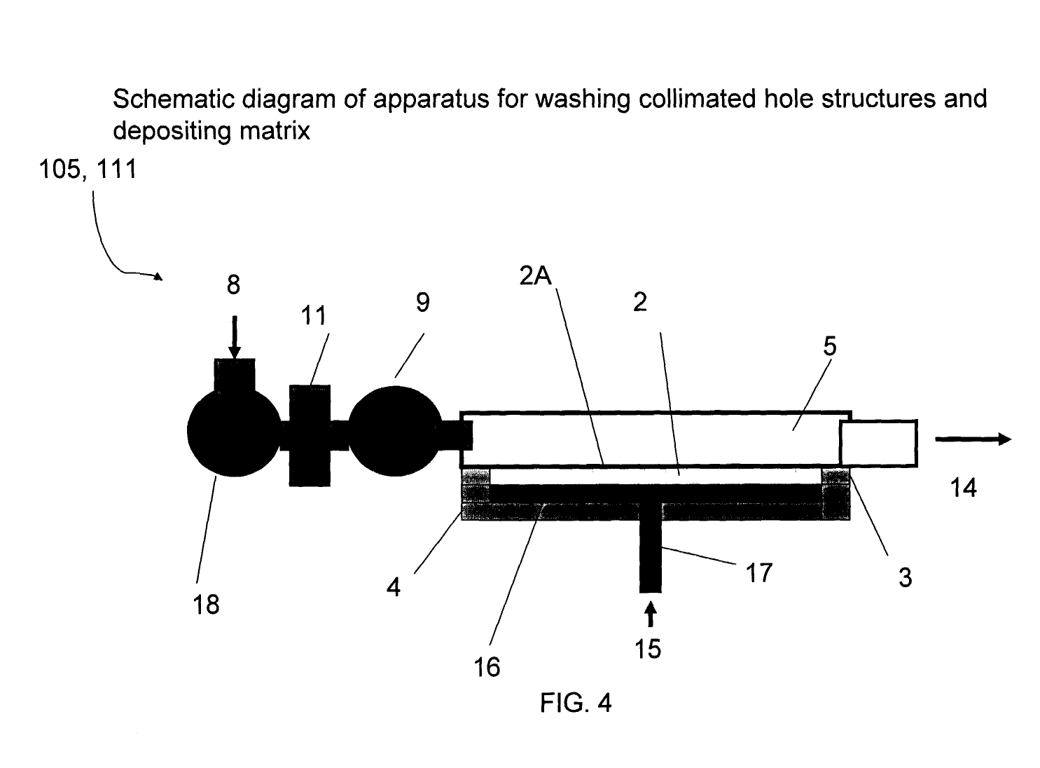

Referring now to FIG. 4. An apparatus for deposition of matrix or washing of sample plates is illustrated. In this system the CHS plate 2 is in the same orientation as in the MALDI mass spectrometer and may be either in same or inverted orientation relative to the apparatus for loading samples from the LC. The small chamber or reservoir 16 is filled with liquid entering via the liquid inlet 15 through the inlet tube 17. A predetermined volume of liquid is supplied by metering pump, such as a syringe pump to force liquid through the CHS. A blower 18 provides a flow of air across the top surface of the plate 2 and carries liquid droplets or vapor to the vent or exhaust 14.

The apparatus illustrated in FIG. 4 can be employed to elute the samples and cause them to be incorporated in matrix crystals on the first surface 2A of plate 2. For this purpose the reservoir is filled with a solution of a MALDI matrix in predominately organic solvent such as acetonitrile that will efficiently elute samples of interest from the reversed-phase monolithic structures. Sufficient volume of liquid is supplied by the metering pump to fill the collimated holes and cause the liquid to “bead up” on the opposite surface. The flow is then stopped and the liquid allowed to dry and form matrix crystals on the surface. The speed of the drying process can be controlled by adjusting the heat input from the heater 11 and the air flow provided by the blower 18 by adjusting the flow controller 9. In many cases little or no heat is required and only a low flow of ambient air is sufficient, since it appears that the best matrix crystals are often formed with relatively low rates of vaporization. The process can be repeated as necessary to achieve efficient elution of samples to crystals on the surface.

Before elution of samples in matrix solution, it is desirable in many cases to wash the plates to remove any nonvolatile salts that may be co-deposited, or other water soluble impurities that are not retained by the reversed-phase media employed in the monolithic structures. The apparatus illustrated in FIG. 4 can also be employed to wash the samples. For this purpose the reservoir is filled with water or other appropriate solvent that will not elute samples of interest from the monolithic structures but will remove weakly bound contaminants. Sufficient volume of liquid is supplied by the metering pump to fill the collimated holes and cause the liquid droplets to be formed on the opposite surface. A predetermined volume of liquid is provided by the metering pump that may be several times the internal volume of the CHS plate and the liquid droplets formed are carried away in a relatively high liquid flow air. It is not necessary to heat the air since vaporization of the liquid is not required.

Those skilled in the art will recognize that the same apparatus could be used for both matrix deposition and sample washing merely by changing the solvent employed and other operating conditions. Similarly, these functions could be incorporated into the apparatus employed for depositing samples from the separation device onto the CHS plate. Thus, the invention is not limited to the case described above in which these operations are carried out in separate apparatus, but rather encompasses any combination that accomplishes the required functions.

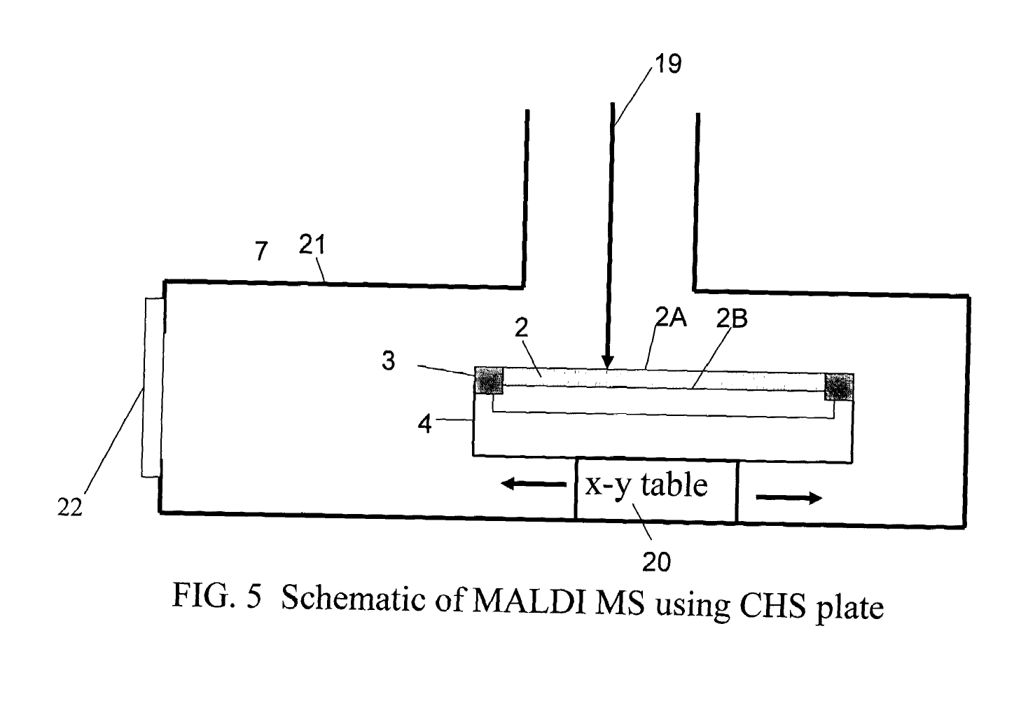

After the samples are dried in crystals on surface 2A the plate 2 is moved to the MALDI mass spectrometer and installed on the x-y table 20 within the vacuum system 21 as illustrated in FIG. 5. In the figure, entry is achieved via a flap valve 22. The plate 2 is oriented with surface 2A containing samples of interest in matrix crystals exposed to the laser beam 23, and MALDI mass spectra are recorded.

### Operation of the LC Interface

In one example the flow rate is 1 mL/min and the nominal spot size is 3 mm. The distance between the first and second position is 4.5 mm, as is the distance between the second and third, etc. Thus, 24 spots may be placed in a row along the 108 mm dimension of the plate, and 22 rows of such spots along the 102 mm dimension for a total of 528 spots. This application may employ a version of the CHS plate that has a separate hole filled with a reversed-phase monolithic structure at each location. One of the advantages of this system over interfaces employing solid sample plates is that the time that effluent is placed on a particular spot is not limited by the size of the spot. Thus, the time resolution and volume of liquid applied to a spot can be determined by the requirements of the chromatography, rather than limitations of the interface.

Any sampling time between 0.1 and 10 seconds can easily be accommodated with this embodiment operating at a flow of 1 mL/min. On the other hand, a solid sample plate operating at 1 mL/min would limit the sampling time for a 3 mm diameter spot to less than 0.2 sec. With typical peak widths on the order of 5-6 seconds, the maximum sample concentration in a spot is reduced by a factor of about 25, and the plate is filled with less than 2 minutes of chromatography.

According to the present invention, a mass spectrometry-LC interface has been developed that allows nonvolatile samples in LC effluents at any flow rate from 1 uL/min to 1 mL/min to be deposited on a collimated hole structure (CHS) with no loss in sensitivity. The area of sample spots on the MALDI plate is proportional to the flow rate, and range in diameter from 3 mm at a flow of 1 mL/min down to about 0.1 mm at a flow of 1 uL/min. Thus, the sample concentration on the surface (mole/mm²) depends only on the concentration of the sample in the LC effluent and the deposition time, but is independent of flow rate.

Unlike other LC-MS systems, here chromatography can be designed according to the total amount of sample available rather than the limits of the mass spectrometer. In applications such as the present one where the total amount of sample available may be relatively large (at least 1 mL) the concentration of trace components is limiting sensitivity rather than the absolute amount of sample. In this case, high capacity separation systems are required using large columns and high flow rates. The interface of the present invention directly interfaces these to the MALDI plate.

The detection limit in MALDI is primarily limited by chemical noise and is typically about 1 fmole/mm² for proteins down to about 1 attomole/mm² for some peptides. The area of the spot for 1 mL/min flow is about 7 mm²; thus with about 6 second deposition the detection limit for proteins corresponds to an average concentration of about 70 fmoles/mL in a 0.1 mL fraction. The detection limits expressed in concentration units are independent of flow rate, but the larger total amount of sample per spot and larger sample spot produced at higher flow rates allows larger numbers of laser shots to be employed when necessary, for example in MS-MS. The deposition time can be chosen to match the chromatography. For example, if the deposition time is approximately equal to the peak width (FWHM), then in the worst case at least one-half of the total sample will be in one spot. Since the samples can be washed to remove salts before the MALDI matrix is added, any type of chromatography can be employed without sacrificing performance of the MS.

From the foregoing detailed description of specific embodiments of the invention, it should be apparent that methods and apparatuses for MALDI-TOF mass spectrometric LC interfacing using a collimated hole structure sample plate have been disclosed. Although specific embodiments of the invention have been disclosed herein in detail, this has been done solely to describe various features and aspects of the invention, and is not intended to be limiting with respect to the scope of the invention. It is contemplated that various substitutions, alterations, and modifications may be made to the embodiments disclosed herein, including but not limited to those implementation variations and alternatives that have been specifically discussed herein, without departing from the spirit and scope of the invention as defined in the appended claims, which follow.

While this invention has been particularly shown and described with references to preferred embodiments thereof, it will be understood by those skilled in the art that various changes in form and details may be made therein without departing from the scope of the invention encompassed by the appended claims.

What is claimed is:

1. An interface system coupling MALDI mass spectrometry and liquid separations comprising:
a. a collimated hole structure sample plate,
b. a sample deposition apparatus which receives liquid effluent from a liquid separations system and which deposits said liquid effluent onto the collimated hole structure sample plate of (a) at predetermined locations; and
c. a matrix deposition apparatus which deposits MALDI matrix onto a collimated hole structure sample plate having samples deposited thereon.

2. The interface system of claim 1 further comprising a washing apparatus.

3. The interface system of claim 1, wherein the liquid separations system employs either high performance liquid chromatography or reversed-phase high performance liquid chromatography.

4. The interface system of claim 3, wherein the collimated hole structure sample plate comprises a reversed-phase monolithic structure within the holes that is more hydrophobic than the media used for the separation.

5. The interface system of claim 1, wherein the collimated hole structure sample plate has a high capture capacity.

6. The interface system of claim 1, wherein the liquid flow through the collimated hole structure sample plate is driven by a pressure differential between the atmospheres adjacent to opposite surfaces of the collimated hole structure sample plate.

7. The interface system of claim 1, wherein the liquid flow through the collimated hole structure sample plate is driven by a differential between the pressure within the supplied liquid effluent and the atmosphere adjacent to opposite surface of the collimated hole structure sample plate.

8. The interface system of claim 1 further comprising a gas inlet and gas outlet.

9. The interface system of claim 8, wherein any excess liquid effluent passing through the collimated hole structure sample plate is carried away as liquid droplets in a flowing stream of gas.

10. The interface system of claim 8 further comprising a gas heater and a blower.

11. The interface system of claim 10, wherein any excess liquid effluent passing through the collimated hole structure sample plate is vaporized at the opposite surface of the collimated hole structure sample plate by a flowing stream of heated gas.

12. The interface system of claim 1 optionally equipped with pressure supply system for generating pressure differential across the collimated hole structure sample plate.
